(19) United States
(12) Patent Application Publication
(10) Pub. No.: US 2025/0328843 A1
(43) Pub. Date: Oct. 23, 2025

(54) DIGITALIZING ENVIRONMENT INDUCED RISK STATE IN HUMANS

(71) Applicant: Dell Products L.P., Round Rock, TX (US)

(72) Inventors: Marcus Vinicius Libardi Pazini, Caxias do Sul (BR); Herberth Birck Fröhlich, Florianópolis (BR); Vinicius Michel Gottin, Rio de Janeiro (BR)

(21) Appl. No.: 18/638,591

(22) Filed: Apr. 17, 2024

(51) Int. Cl. G06Q 10/0635; G06V 10/40

(52) U.S. Cl. CPC G06Q 10/0635; G06V 10/40

(57) ABSTRACT

One example method includes receiving, by a platform from a first module associated with a device configured to function in an operating environment, environment attribute data concerning attributes of the operating environment, receiving, by the platform from a second module associated with the device, human operator data concerning attributes of a human operator of the device, applying an ontology to the environment attribute data and to the human operator data, based on the applying of the ontology, determining risk state information concerning the human operator, and updating a digital twin with the risk state information.

### FIELD OF THE INVENTION

Embodiments of the present invention generally relate to capturing and using risk information in environments that involve human operators. More particularly, at least some embodiments of the invention relate to systems, hardware, software, computer-readable media, and methods, for generating a digital twin that includes information indicating one or more risks associated with a particular human in a particular environment.

### BACKGROUND

During working hours, workers are exposed to many varying environmental conditions and are required to perform complex and constant tasks that require a great degree of space awareness and attention to their surroundings. Those adverse conditions increase the risk of accidents when workers are executing activities such as operating heavy machinery or driving vehicles, leading to accidents in the workplace.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses an overview of method according to one example embodiment.

FIG. 2 discloses aspects of an example domain and data gathering scheme for an embodiment of the environment.

FIG. 3 discloses aspects of example interactions between modules, according to one embodiment.

FIG. 4 discloses an example of image capture, according to one embodiment.

FIG. 5 discloses an example functional pipeline and associated ontology, according to one embodiment.

FIG. 6 discloses an application of an ontology, according to one embodiment.

FIG. 7 discloses thresholds for example classes according to one embodiment.

FIG. 8 discloses a computing entity configured and operable to perform any of the disclosed methods, processes, and operations.

### DETAILED DESCRIPTION OF SOME EXAMPLE EMBODIMENTS

Embodiments of the present invention generally relate to capturing and using risk information in environments that involve human operators. More particularly, at least some embodiments of the invention relate to systems, hardware, software, computer-readable media, and methods, for generating a digital twin that includes information indicating one or more risks associated with a particular human in a particular environment.

A method according to one example embodiment comprises the operations of: performing, using one or more sensors for example, a signal acquisition process to gather real-world data about a human operator and associated operating environment; performing a feature extraction process on the real-world data; applying an ontology to the extracted features; and, based on an outcome of the application of the ontology, creating or updating a DT (digital twin) that corresponds to the human operator. In an embodiment, the digital twin information may be used as a basis for identifying, and implementing, one or more actions concerning the human operator and/or the associated operating environment.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in anyway. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of embodiment is that an embodiment may estimate a degree of risk with respect to operations performed by, and/or at the direction of, a human in an operating environment. An embodiment may develop risk information that can be used to inform and implement risk mitigation procedures. An embodiment maygenerate a digital twin that quantifies a level of risk associated with the behavior of a particular human in an operating environment. Various other advantages of one or more example embodiments will be apparent from this disclosure.

### A. Introduction

### A.1 References

Reference is made in this disclosure to various documents. These documents are listed below according to reference number, and are incorporated herein in their respective entireties by this reference.
[1]E. Talebi, W. P. Rogers and F. A. Drews, “Environmental and Work Factors That Drive Fatigue of Individual Haul Truck Drivers,” Mining, 2022.
[2]Y. Fan, J. Liang and X. Cao, “Effects of Noise Exposure and Mental Workload on Physiological Responses during Task Execution,” International Journal of Environmental Research and Public Health, 2022.
[3]M. R. ZARE, “Noise Pollution Effects on Mental Fatigue and Noise Annoyance,” INTERNATIONAL JOURNAL OF OCCUPATIONAL HYGIENE, p. 11, 2019.
[4]O. S. a. H. Administration, “https://www.osha.gov/,” US Department of Labor, [Online]. Available: https://www.osha.gov/noise#:˜:text=to%20safeguard%20themselves.-, Health %20Effects,through%20surgery%20or%20with%20medicine. [Accessed 6 Jan. 2023].
[5]S. E. Lerman, D. J. Flower, B. Gerson and S. R. Hursh, “Fatigue Risk Management in the Workplace,” Journal of Occupational and Environmental Medicine, 2012.
[6]G.-S. Lee, M.-L. Chen and G.-Y. Wang, “Evoked response of heart rate variability using short-duration white noise,” Autonomic Neuroscience: Basic and Clinical, 2010.
[7]K. Peng, A. Roitberg, K. Yang, J. Zhang and R. Stiefelhagen, “TransDARC: Transformer-based Driver Activity Recognition with Latent Space Feature Calibration,” arXiv preprint arXiv:2203.00927, 2022.
[8]G. S. Krishna, K. Supriya, J. Vardhan and M. R. K, “Vision Transformers and YoloV5 based Driver Drowsiness Detection Framework,” arXiv:2209.01401, 2022.
[9]Z. A. Haq and Z. Hasan, “Eye-Blink rate detection for fatigue determination,” 2016 1st India International Conference on Information Processing (IICIP), 2016.
[10]D. Z. Yaxi Chen and G. He, “Deep Learning-Based Fatigue Detection for Online Learners,” in 2022 the 5th International Conference on Pattern Recognition and Artificial Intelligence, Chengdu, 2022.
[11]Centers for Disease Control and Prevention, “What Noises Cause Hearing Loss,” US Government, 8 Nov. 2022. [Online]. Available: https://www.cdc.gov/nceh/hearing_loss/what_noises_cause_hearing_loss.html. [Accessed 6 Jan. 2023].

### A.2 Discussion

One example embodiment involves the monitoring of workers in risk-prone scenarios with digital twin applications. One illustrative embodiment is concerned with an industrial safety case, but the scope of the invention is not limited to that domain and, accordingly, extends to various other domains as well, including, but not limited to, construction sites, and logistics operations, in which digital twins may be employed and human workers are subject to risks of some kind stemming from the environment in which they are present.

In more detail, one embodiment comprises a method to combine data acquired from sensors—in place at the edge environment, such as cameras, microphones, and others—to assess, quantify and incorporate the risk state of workers in a DT platform, providing a virtual entity that represents the condition of the worker, both at discrete instances, and over a time interval. In an embodiment, the DT, or virtual entity, is created by mapping previous domain knowledge for constructing an ontology to determining the risk of certain operations when performed by a risk prone worker. This approach also enables quantification of how long it would be expected to take for a worker to reach an unacceptable state of operational risk, and also provides for digitally monitoring the risk this worker presents to himself and others, through the use of a DT platform.

The consolidation of this virtual entity as a Digital Twin of a worker enables data to be gathered over time, relating the data gathered by a deployed sensor to the operational risk affecting the worker, as annotated by the ontology. Later, as enough data is gathered and labeled, the approach may be replaced by, or applied simultaneously with, an ML (machine learning) model that has been trained to infer the risk state of the worker from the sensor data.

In an embodiment, executing this service comprises mounting a set of sensors in the workplace, but may also leverage existing sensors deployed for operational and monitoring purposes, as is typical in some environments supported by a DT. Example sensors include, but are not limited to, cameras both still and video, microphones, and thermometers, smoke and dust sensors and alarms, vibration sensors, toxic gas sensors, also with other kinds of applicable sensors which may vary depending on the domain in which the method is applied.

In general, the sensors provide information that enables monitoring the behavior of workers as they perform various activities in a particular working environment. Those data may initially be the features for the ontology, and later may be used for training an ML model.

With regard to one example embodiment at least, a benefit is the ability to leverage formal domain knowledge to both perform a risk assessment, as well as to provide annotated, or ‘labeled,’ data for the training of an ML model to extend and/or support the risk state monitoring. Additional benefits of an embodiment include the ability to virtualize the risk state of a worker so that risk state can act as a virtual entity a DT platform. As well, an embodiment may inform the risk level that a worker and the surrounding people are subjected to, so workers can take breaks, or be redirected to work in a less critical operation or zone, and thereby help to avoid accidents in the workplace.

### B. Aspects of an Example Embodiment

One embodiment comprises the real-time/quasi-real time monitoring of workers and their surroundings with domain relevant sensors. These sensors may comprise thermometers, cameras, microphones, vibration sensors or others, depending on the specific domain. One embodiment operates to leverage this acquired information, as well as, whenever needed, combining the existing data with other sources specifically intended for this task, to build a set of features for models that output a digital measure for the many states that are possible for a worker to be in, such as, but not limited to, fatigued, drowsy, sick, impaired.

In an embodiment, there are two types of models that may be employed to execute this task, namely, ontologies, based in domain knowledge, and ML models, trained with labeled data. It is noted that in some cases, labeled data may not exist, this may be especially likely to be the case at the beginning of operations when sensors are initially deployed, but also generally because of the variety and volume of available data. Thus, the use of machine learning at the outset of a method according to one embodiment may not be feasible, and the application of an ontology based in information about the problem domain may be the more effective approach in such circumstances. However, as time passes and workers are monitored, the incoming data may be classified to form a corpus of labeled data for the training of ML models. An embodiment may leverage the ontology as a source of labeled data for models, such as classifiers, that may be trained as data is gathered (online learning) or after some dataset is built (standard supervised learning).

In a more concrete example, an embodiment may use data from workers that are classified with a certain state S1 in a location L1 monitored with a specific set of information I_{L1} and are later moved, that is, the workers are moved, to a different location L2 where the monitoring is different, I_{L2} (for example, a worker that in time t works in a welding station (1) where high temperatures, fumes and light (I_{L1}) produces the fatigue state S1 and is later moved to a packaging function (L2), where it is necessary for the worker to move around a large product around other people (I_{L2})). However, the state remains the same S1, thus, if this dataset is available, ML models could become much better and more flexible in their ability to classify situations, as compared to ontologies. Thus, an embodiment may use this characteristic of the problem domain to generate and train ML models capable of generalizing for a broad range of conditions while continuously being trained by the data labeled for the domain expert, that is, the ontology.

As will be apparent from this disclosure, example embodiments may comprise various useful features and aspects, although no embodiment is required to possess any particular feature or aspect. The following examples are illustrative. An embodiment may construct and employ a unifying framework to run on edge/fog environments to estimate the degree of risk present in a worker by collecting data from the worker and the surrounding environment in real time. An embodiment may implement the virtualization of the risk present in human workers as a feature for utilization in DT/ML (Digital Twin/Machine Learning) applications.

### C. Detailed Discussion of Aspects of an Example Embodiment

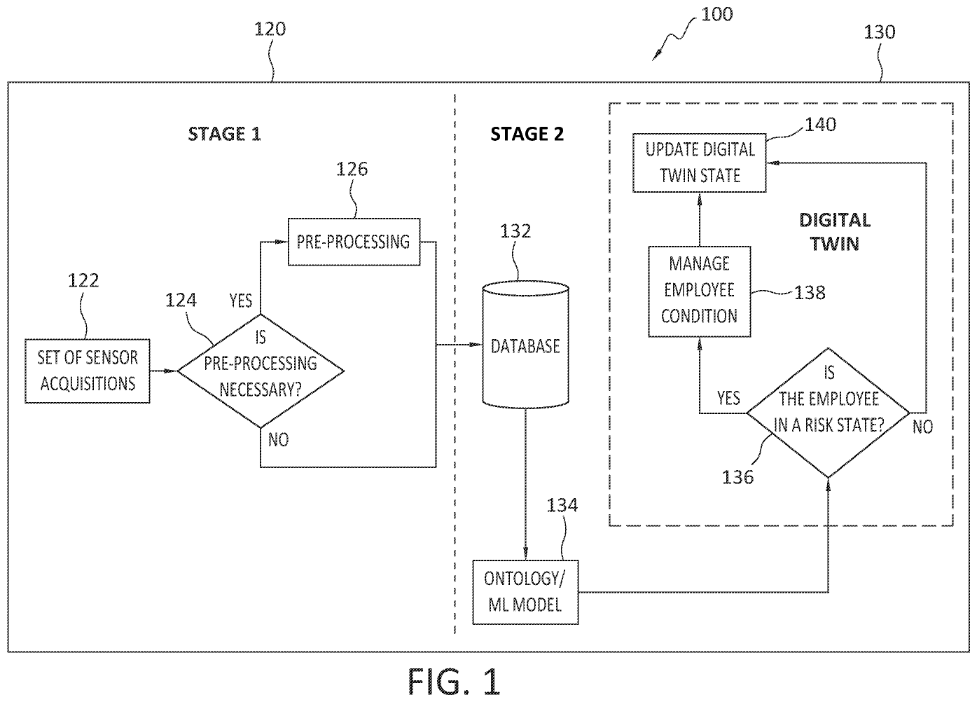

An embodiment comprises a method that combines data acquired from sensors to assess the risk state undergone by workers, and then incorporates this information in a DT platform, providing the virtual entity that indicates the condition of the worker. FIG. 1 discloses a method 100 according to an example embodiment. As shown, the method 100 may comprise two stages, namely a first stage 120, and a second stage 130, and the output of the first stage 120 may compose the input for the second stage 130. In the first stage 120, measurements generated by various sensors are acquired 122. Then, a check 124 is performed to determine if any preprocessing is needed to be performed. If so, the method may proceed to 126 where features are extracted from the data that was acquired 122 from the sensors. The check 124 may be performed recursively until it is determined that no further preprocessing is needed. The extracted features, and their associated information and metadata, such as the time, date, and nature, of the data collection, may be stored 132 in a database.

Next, an ontology and/or ML model may be applied 134 to the features, and a check performed 136 to determine whether, based on the application of the ontology/ML model to the features, whether or not the relevant worker is in a risk state. If the determination 136 reveals that the worker is in a risk state, one or more actions 138, which may involve the worker and/or the environment, may be taken to mitigate the risk. The state of the DT may then be updated 140 to indicate the condition of the worker, and the update may include identification of the action(s) taken at 138. In this way, the outcome of the application of the ontology/ML model may be used to update the digital twin software to indicate the risk state of the worker. In general, the risk state may inform the management, and/or others, of the employee condition, so that the management can take the action(s)138 which may include, for example, reallocating or reassigning employees, signaling alarm(s), or affecting changes to the environment. The digital twin state, and update, information may be stored 140 in the database, along with the data gathered from the sensors, as noted earlier.

If it is determined 136 that the employee is not in a risk state, the method may advance to 140, where the state of the DT is updated to indicate the then-current state of the employee. In this way, the current state of the employee may be maintained, and updated as needed, even if the employee is not in a risk state.

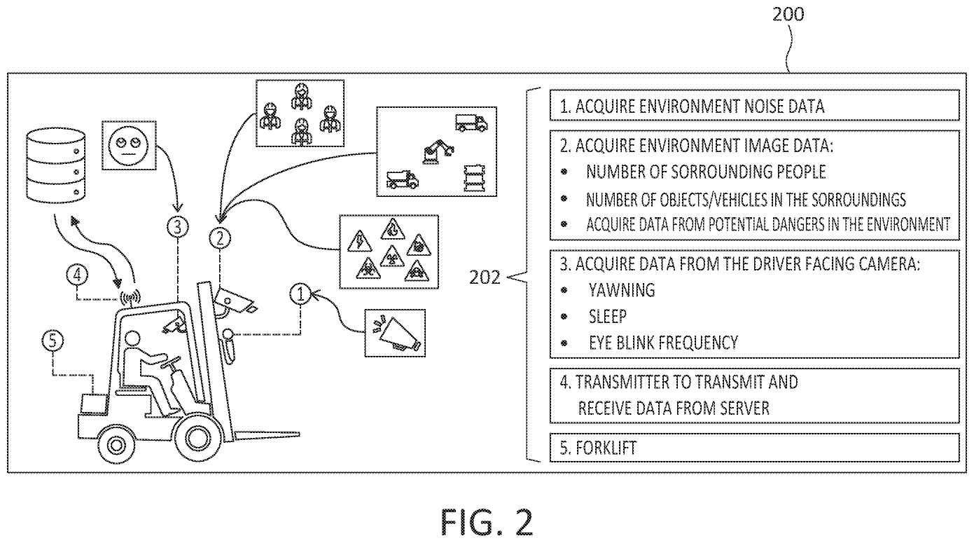

In the discussion hereafter, the of a risk estimation of forklift operators is adopted as an illustrative example, but is not intended to limit the scope of the invention in any way. In fact, a human may be subject to, and/or present, a risk of some kind in a wide variety of scenarios. In the illustrative scenario, the forklift operator drives through many locations that may have different types of adverse conditions and may be subject to stress and mental fatigue. This is disclosed in FIG. 2 which shows, in particular, an example scheme of some components/sensors mounted on the forklift for a fatigue related data acquisition stage of an embodiment.

In particular, FIG. 2 discloses, in an example configuration 200, how existing sensor components, such as cameras and microphones, for example—which are already typically in place for operation in this example environment—may be leveraged for extracting features from the actions of the worker. In this example, to track the surroundings and the worker, a front-mounted camera (component 2) is used to identify obstacles, a microphone (component 1) to identify loud environments and a camera (component 3) facing the driver to capture facial cues indicating fatigue. In the forklift (component 5) there is a transmitter (component 4) to transfer and receive data from a database (FIG. 2).

The example configuration 200 comprises one in which an embodiment of stage 1 (see FIG. 1) may be implemented. FIG. 2 also discloses an example method 202, and associated components for performing aspects of the method 202. In the following sections, various processes according to an example method are discussed in detail, and are related to the example embodiment of risk estimation for forklift operators which, as noted, should not be construed as limiting the scope of the invention in any way.

### C.1 Data Capture Modules

In stage 1 of an embodiment (see, for example, FIG. 1), a determination is made as to the different kinds of modules to be employed, each one configured to handle a specific type of data acquired from specific sensors, for example, an audio module is for audio processing, and an image module for video/image data processing. That is, an embodiment may assume modules corresponding to the available sensor data, defined to perform the data acquisition and processing of that data for feature extraction. For each sensor, or set of related sensors as the case may be, an embodiment may assume that a module is deployed to perform operations including:
orchestrating the data ingestion;
performing any necessary, domain-specific, processing or inference related to those sensors for feature extraction; and
informing and storing the obtained features leveraging an ontology.

In an embodiment, each module used to collect and process data may comprise a respective algorithm(s), which may each comprise an ML model, but other techniques may be used as well. The algorithms each implement the function of extracting, from the data collected by a particular sensor or sensor type, those features needed to determine the risk state of a worker.

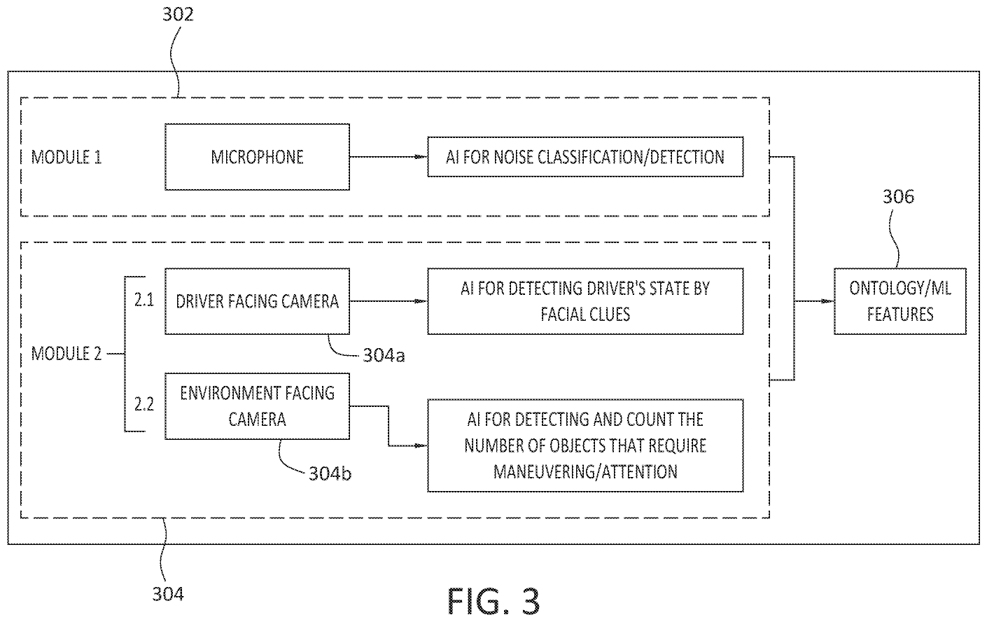

Thus, for determining the algorithms to be embedded in each module, a domain expert, such as a human, may first determine which features are needed for the inference of the risk state. In the example of the forklift scenario introduced earlier herein, those modules are assembled on the vehicle to perform data acquisitions and, when necessary, the data is processed to extract the features used by the ontology so that the risk state can be inferred. In the illustrative forklift example, and with reference now to FIG. 3, two modules are used, namely, an audio module 302 and a computer vision module 304.

As shown in FIG. 3, a module, such as the module 304, may be divided in submodules such as the submodules 304a and 304b, depending on the related sensor available. In the example case of the module 304, the submodules comprise the submodule 304a for the driver images, and the submodule 304b for the environment images. Note that as used herein, ‘images’ embraces video, still images, and combinations of video and still images.

In an embodiment, each module concerns feature extraction. In the illustrative example of FIG. 3:
the audio module 302 is responsible for noise classification/detection by way of a microphone and includes AI for that purpose;
the driver facing camera 304a AI detects facial cues of fatigue; and
the environment camera 304b AI detects and counts objects that require the driver to be extra careful or maintain focus for an extended period.

Typically, the feature extraction is domain-dependent and must be provided. In the example of FIG. 3, both modules 302 and 304 rely on feature extraction using AI (artificial intelligence) techniques. If necessary, other methods for feature extraction from data may be implemented or leveraged from the domain if pre-existing. The examples of audio and image processing modules in FIG. 3 are typically related to multiple use cases. Hereafter, details are provided concerning some details of examples of such data capturing modules, highlighting that these cases can be further generalized for multiple other scenarios in which a human worker is under conditions that increase stress/risk, and where data is available.

With continued reference to the example of FIG. 3, it can be seen that the various features extracted from the data collected by the modules can be input to an ontology/ML model 306. Further details concerning an example ontology are provided elsewhere in this disclosure. Following is a discussion of aspects of some specific implementations of modules, including an audio capture module, and computer vision modules.

### C.1.1 Audio Capture Modules

It is well known that loud environments and noise pollution are large contributors for fatigue in the workplace and managing noise exposure is beneficial to the overall wellbeing of workers (see references [1], [2], and [3]) so there exists a variety of legislation that regulates the permitted time of exposure and the magnitude of noise acceptable. For example, the Center for Disease Control (CDC) estimates that 22 million workers are exposed to potentially damaging noise at work each year and the United States Department of Labor alerts that “exposure to loud noise kills the nerve endings in our inner ear. More exposure will result in more dead nerve endings.” See reference [4].

Research also shows that even if exposure to noise for an extended period may ameliorate performance decline due to circadian cycle effects. This effect depends on variables such as the noise and the task. In other hand, drawbacks such as subjective feelings of unpleasantness and increase in complaints of fatigue may result from noise exposure. See reference [5].

Fatigue induced by noise was also studied in a more quantitative way, and it was shown that additional effort is needed to complete tasks under adverse noise conditions. Heart rate variability (HRV) was significantly associated with noise intensity. Reference [6] discloses that the frequency-domain HRV parameters increased significantly with elevated noise intensity from 23 dB (A) to 80 dB (A).

With this information at hand, the audio capture module 302 of FIG. 3 is responsible for processing the microphone acquired data and determining for how long a driver is subjected to elevated noise (in dB) and the sound quality (sharpness) that the worker is subjected to. The sound level in dB calculated from the microphone data by applying the following equation to the signal.

$${I}_{d B} = 10 {log}_{10} ( \frac{{S}_{1}}{{S}_{0}} ) ,$$

where S₀ is the amplitude of a standard signal captured by the microphone emitted at 20 μPa (the lowest hearing threshold of the human hearing) and S₁ is the amplitude of the captured signal. The sound sharpness may be obtained by Fourier Transform, which will receive the sound captured, and output the frequencies present and their intensity.

### C.1.2 Computer Vision Modules

In computer vision modules, such as the module 304 for example, one or more cameras may be utilized for extracting features from video frames. These features may help detecting necessary cues about the state of an employee, that might be relevant for determining the level of fatigue or risk to operations. This detection may comprise pose estimation, gaze detection, or other operations. With respect, for example, to the driver facing camera as a mechanism to leverage information that is relevant for the execution of the driving task, some of the cues of interest could be, but are not limited to, yawning, blink frequency and drowsiness. If impairment of the employee is a possible concern, data collected by the camera could be evaluated for redness or swelling in the eyes of the employee. In an embodiment, data gathered by a camera may be evaluated to determine whether, and to what extent, the motor skills of the employee may be compromised, for whatever reason(s).

In an embodiment, a computer vision module may be configured, and operate to, monitor the employee surroundings by identifying factors which, if persisting for a prolonged time, could cause fatigue. For example, such factors may include time standing up for too long, or executing a task such as operating heavy equipment surrounded by many people/objects.

It is noted that the scope of the invention is not limited to any particular type, or number, of modules, or to the number of features that may be extracted from a given module, such as a module that includes a camera. For example, there might exist a case where it is possible to estimate all the necessary features from only one image source or others that multiple images are analyzed to extract a feature.

### C.1.2.1 Worker Monitoring

For the worker monitoring example that has been discussed so far, an alternative may be implemented in which a camera, such as the example camera 304a (see FIG. 3) is mounted facing the driver. In an embodiment, this camera captures images from the face of the driver, and may also capture actions of the driver, and then send those images to an already trained algorithm for computer vision (CV) that performs action and sentiment classification such as TransDARC (https://github.com/KPeng9510/TransDARC) and Yolov5 based Drowsiness Detection. See references [7] and [8]. Thus, in this example, a role of the module is to provide tags of the behavior of the driver such as, but not limited to, drowsy, interactions with a phone, eating, motor skill impairment, and blink frequency.

### C.1.2.2 Task Performance Monitoring

Cameras that are deployed to monitor the task(s) performed by a worker and/or to assess the performance may be used as a sensor for data gathering and risk state estimation. Thus, in an embodiment, those images may be processed in an image module to extract the relevant features present in the domain of interest by NLP (natural language program) algorithms or other.

In the example of the forklift use case, this camera (see camera 304b in FIG. 3) is mounted towards the driving lane and operates to provide images used by reliable algorithms such as YoloV5, see reference [5], to estimate outputs such as, but not limited to: number of objects present; bounding box size of objects; and, class of the object. In an embodiment, the time that the worker spent working in this environment is also counted. In an embodiment, all of this information may be utilized by an ontology, and subsequent to that may be utilized for an ML model, to determine the type and complexity of the environment the worker is subjected to and how this affects the ability of the worker to execute one or more tasks safely.

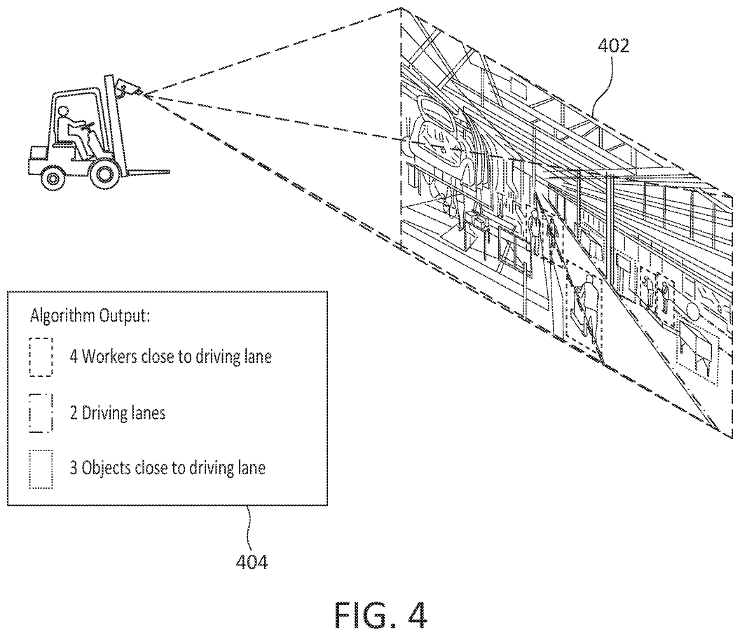

With reference now to FIG. 4, there is disclosed an example of a particular situation that a worker might encounter, and the corresponding output of an algorithm according to one embodiment. In particular, FIG. 4 discloses an image 402 captured by a camera such as the camera 304b (see FIG. 3), and the corresponding output 404 generated after the image 402 been processed by a computer vision algorithm. In this example, the output 404 contains various features which may be utilized to compose a portion of an ontology.

In more detail, as images 402 of a workplace, or other environment, are captured, the CV algorithm processes and outputs the bounding boxes, classes, and number of elements from each class. Once the classification task is completed, the information is sent to a fatigue virtualization module to compose an overall fatigue index. Those features are representative of how populated and hard it is for the worker to maneuver in the ambient environment.

As shown in FIG. 4, the algorithm of the module, comprising a camera in this example, may generate various outputs 404. Such outputs 404 may indicate, for example, that there are 4 drivers driving close to the driving lane of the worker, there are 2 driving lanes, and there are 3 objects close to the driving lane of the worker. These factors are examples of factors that may be taken into account by an embodiment when determining a risk index for the worker.

### C.2 Aspects of an Example Ontology Application and ML

An embodiment may combine the extracted features obtained by the modules and use those features to determine an overall risk index (RI) for the worker. An embodiment may assume that no labeled data is available and the example models noted earlier herein with respect to the forklift example were constructed to provide features necessary for the ontology. It is noted that this may not be mandatory if there is an existing database of labeled data, in which case an ML approach may be straightforwardly applied.

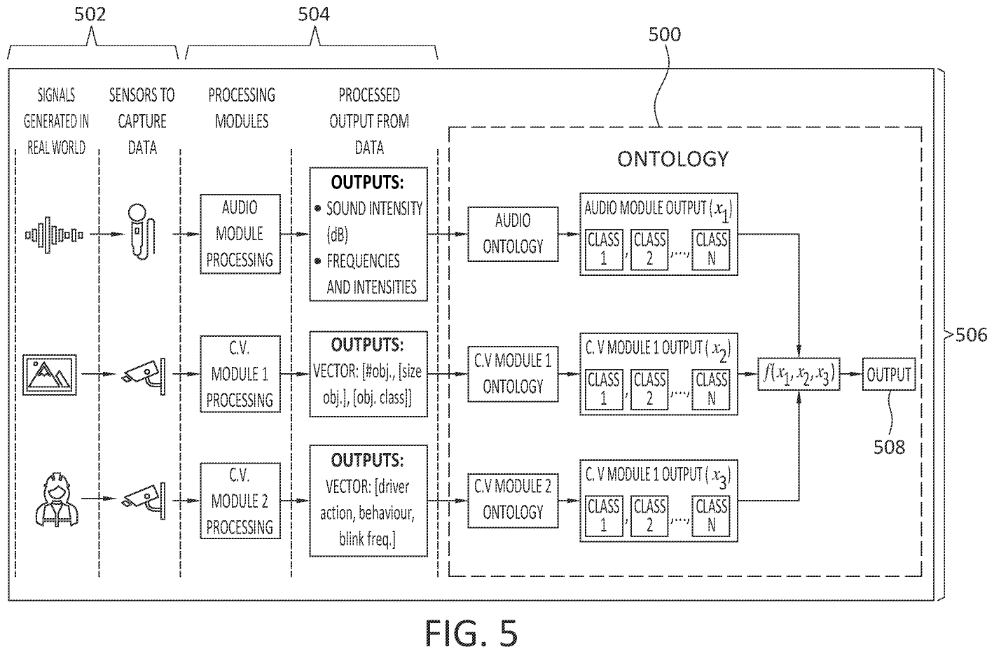

In an embodiment, an ontology, such as the example ontology 500 disclosed in FIG. 5, may be constructed by a human domain expert who analyzes the activity to be monitored, and then develops a heuristic for determining how prone a human worker is to a risk state threshold, which means that if a person continues to work on this current state, he/she can pose a risk to themselves or others. In an embodiment, the ontology can be based on research of human physiology as well as work safety laws, for example.

In the example forklift scenario, the ontology 500 captures all the features extracted from the computer vision modules and audio capturing module to combine them for composing the overall RI. As this illustrative example is concerned with driver fatigue, reference will be made to the risk index as comprising, or consisting of, a fatigue index (FI). FIG. 5 shows how the features may be combined to form the virtualization of the fatigue state of a worker. More specifically, FIG. 5 discloses an example pipeline extending from data acquisition to a final output, that is, the FI concerning a particular worker.

With respect to the example of FIG. 5, the following observations are made:
the function ƒ(x) may be a predefined ontology or, if possible, can be learned from a space of functions F. F={ƒ|ƒ:x→y; y∈ [symbol] }; and
the respective “class bins” from the CV modules and audio module outputs are predefined by user and can be constructed with aid of legislation, which may vary between jurisdictions, and other studies that may be updated to incorporate new findings.

As shown in the example of FIG. 5, an embodiment may comprise three main phases, namely:
1. signal acquisition from a real world environment—502
2. processed data and outputs —504; and
3. application of the risk-state ontology 500-506.

In the example of FIG. 5, Phase 1 502 comprises the sensors and real-world inputs captured by them. Phase 2 504 comprises generating outputs from the collected dataset, thus it is dependent upon Phase 1502. The third phase, Phase 3 506, is then the final objective, which is applying the ontology 500 to the processed data obtained in Phase 2. In the specific illustrative embodiment of forklift operators, the ontology 500 comprises a fatigue ontology.

As shown, the ontology 500 takes into consideration predefined user parameters, which may be based on studies about fatigue behavior, and on local legislation regarding exposure to noise and dangerous workplaces. In an embodiment then, an ontology, such as the ontology 500, is customizable and may be adapted in a case-by-case scenario. However, regardless of the customization chosen, the output 508 may comprise a real number whose magnitude reflects a relative degree of fatigue undergone by an individual. An example of a fatigue ontology is discussed below.

### C.3 Digital Twin (DT) Integration

Once the ontology, such as the ontology 500, is applied and values for RI are calculated, it is possible to integrate this knowledge to a digital twin platform, where a virtual entity of a worker may already exist. The virtual entity of the worker receives their attributed risk state, and this value can be tracked so that once a threshold risk index is reached, remedial actions can be performed to mitigate the risk of accidents or mistakes caused by human error. Note that a risk index may be a function of multiple measures so that, for example, fatigue and loss of motor skills may together define a risk index value. An example of a remedial action may be to manage a worker to a secondary function so the current task can be performed by a more rested worker. The digital twin state and the risk state of operator may be stored in association with each other in a database so a log from past events is created. In this way, information such as a history and trend analyses, for example, may be generated for a given worker.

### C.4 Ml Model Training

Once the integration with the digital twin is made and the system works for a considerable amount of time, an ML model, or simply ‘model’ herein, may be trained with labeled data from the past operations of the system, via supervised learning. The type of model may be, for example, models such as neural networks or gaussian process regression, although the scope of the invention is not limited to the use of any particular model(s). The developed model may be utilized for inference of the risk state by itself, or may be combined with the ontology in an ensemble. All those choices are case-dependent and must be decided depending on the specific scenario of interest.

### D. Example Use Case

Following is a numerical example of an implementation of an embodiment in the form of an ontology. The case corresponds to the forklift scenario discussed earlier herein.

### D.1 Ontology Application

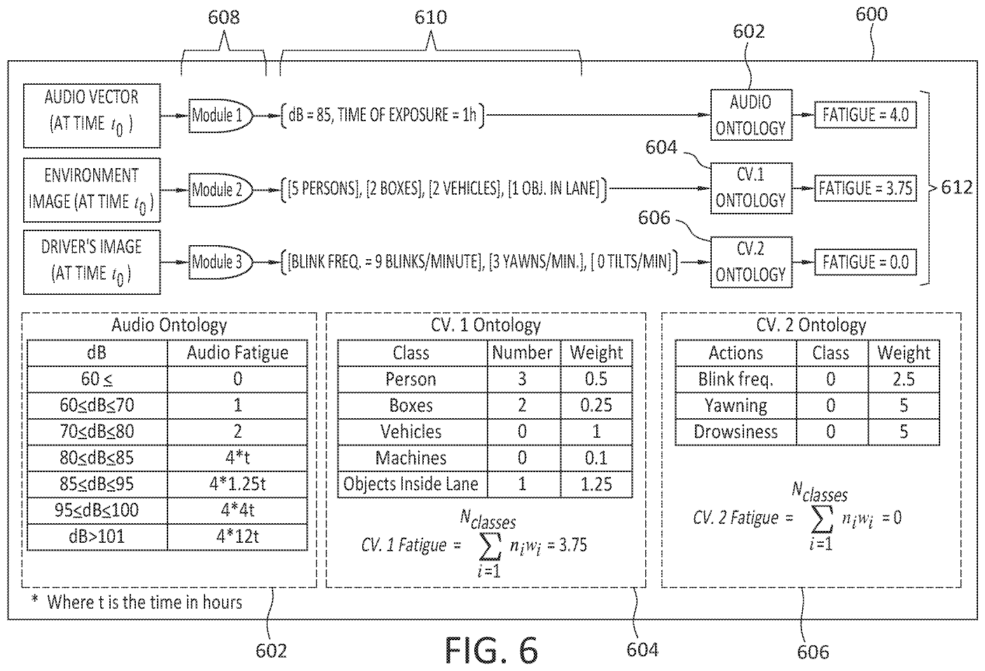

Suppose there is a fully instrumented asset that captures and provides real world data to modules such as those disclosed herein (see, for example, FIG. 3). In this situation, a domain expert may analyze this scenario and develop an ontology 600, which may comprise various tables 602, 604, and 606, as disclosed in FIG. 6. It is noted that no particular form or content of an ontology is required. Thus, the ontology 600 is provided only by way of example and is not intended to limit the scope of the invention in any way.

As shown in the example of FIG. 6, the data, which may be in vector form, acquired from the cameras and microphone are processed by the modules 1, 2 and 3, generally indicated at 608. This processing may generate the outputs, generally indicated at 610, related to the environment and driver. Subsequently these outputs, or features, are inserted into corresponding ontologies. The ontologies may then generate fatigue values 612, and then compare these values 612 to corresponding pre-determined thresholds, to determine if, in this example, a fatigue threshold has been exceeded. If so, the ontology may warn that the worker is fatigued, and one or more remedial actions should be taken.

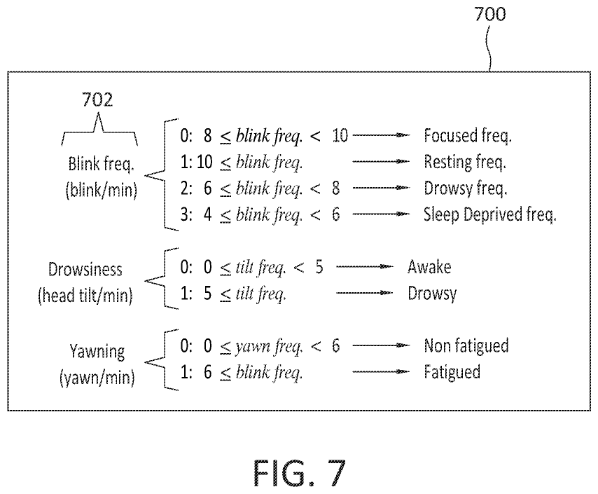

FIG. 7 discloses an example ontology 700, corresponding to the ontology 606 of FIG. 2, that includes three classes, generally indicated at 702. The numerical results indicated in the ontology 700 are obtained by the following equation.

$$F . I = {\sum }_{i = 1}^{Modu l e s} {fatigue}_{i} = 7.75$$

In the present example, the sum in this equation (immediately above) represents the equation ƒ(x₁,x₂,x₃) seen in FIG. 5. In another embodiment, this summation may be any other user defined function. Once calculated, the F.I index may be shared with a digital twin software, as shown in FIG. 1 for example, to be incorporated with all other existing information about a particular worker, thus enriching and improving the virtual entity resemblance to the real-world scenario.

The resulting F.I. obtained with the preceding equation has a value of 7.75 (sum of fatigue values 612 from FIG. 6), meaning that if the fatigue threshold is set to 8.0, for example, the driver could be reallocated to a place where the fatigue due to audio related features are smaller, or to a place with less intense movement of people/objects to lower his/her fatigue index, or even recommended to take a break. It is noted that, with regard to this illustrative and non-limiting example, the weights attributed to each class, and the limits for defining the boundary of each class, are extracted from references [9], [10], and [11], and may be altered in a case-by-case scenario, as well as being enriched by further information.

### E. Example Methods

It is noted with respect to the disclosed methods, including the example methods of FIGS. 1-3, 5, and 6, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

In one embodiment, a method may be performed at a platform, such as a server for example, that is able to receive data from modules deployed on devices operating in an environment where data will be collected concerning a human operator. The data may or may not have been pre-processed by the modules before transmission to the platform. The platform may update a digital twin, which may or may not be an element of the platform, to include updates based on the data gathered by the modules of the devices.

### F. Further Example Embodiments

Following are some further example embodiments of the invention. These are presented only by way of example and are not intended to limit the scope of the invention in any way.

Embodiment 1. A method, comprising: receiving, by a platform from a first module associated with a device configured to function in an operating environment, environment attribute data concerning attributes of the operating environment; receiving, by the platform from a second module associated with the device, human operator data concerning attributes of a human operator of the device; applying an ontology to the environment attribute data and to the human operator data; based on the applying of the ontology, determining risk state information concerning the human operator; and updating a digital twin with the risk state information.

Embodiment 2. The method as recited in any preceding embodiment, wherein the first module comprises a camera and the human operator data was captured by the camera.

Embodiment 3. The method as recited in any preceding embodiment, wherein the second module comprises a microphone and the environment attribute data was captured with the microphone.

Embodiment 4. The method as recited in any preceding embodiment, wherein the environment attribute data and/or the human operator data were processed by respective ML (machine learning) models prior to receipt by the platform.

Embodiment 5. The method as recited in any preceding embodiment, wherein the digital twin represents a condition of the human operator.

Embodiment 6. The method as recited in any preceding embodiment, wherein the Docket No: 16192.1000 risk state indicates a relative risk that the human operator will be involved in an accident in the operating environment.

Embodiment 7. The method as recited in any preceding embodiment, wherein when a value of the risk state exceeds a threshold, a remedial action is taken.

Embodiment 8. The method as recited in any preceding embodiment, wherein the environment attribute data comprises data about physical attributes of the environment.

Embodiment 9. The method as recited in any preceding embodiment, wherein the human operator data comprises data about physical attributes of the human operator.

Embodiment 10. The method as recited in any preceding embodiment, wherein the environment attribute data received from the first module comprises features extracted by the first module from data obtained with a microphone and/or a camera, and the human operator data received from the second module comprises features extracted by the second module from data obtained with another camera.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

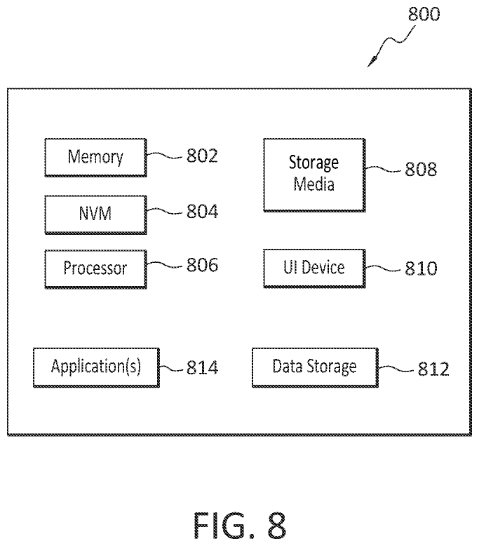

With reference briefly now to FIG. 8, any one or more of the entities disclosed, or implied, by FIGS. 1-7, and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 8.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 802 of the physical computing device 800 may take the form of solid state device (SSD) storage. As well, one or more applications 814 may be provided that comprise instructions executable by one or more hardware processors 806 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, by a platform from a first module associated with a device configured to function in an operating environment, environment attribute data concerning attributes of the operating environment;
receiving, by the platform from a second module associated with the device, human operator data concerning attributes of a human operator of the device;
applying an ontology to the environment attribute data and to the human operator data;
based on the applying of the ontology, determining risk state information concerning the human operator; and
updating a digital twin with the risk state information.

2. The method as recited in claim 1, wherein the first module comprises a camera and the human operator data was captured by the camera.

3. The method as recited in claim 1, wherein the second module comprises a microphone and the environment attribute data was captured with the microphone.

4. The method as recited in claim 1, wherein the environment attribute data and/or the human operator data were processed by respective ML (machine learning) models prior to receipt by the platform.

5. The method as recited in claim 1, wherein the digital twin represents a condition of the human operator.

6. The method as recited in claim 1, wherein the risk state indicates a relative risk that the human operator will be involved in an accident in the operating environment.

7. The method as recited in claim 1, wherein when a value of the risk state exceeds a threshold, a remedial action is taken.

8. The method as recited in claim 1, wherein the environment attribute data comprises data about physical attributes of the environment.

9. The method as recited in claim 1, wherein the human operator data comprises data about physical attributes of the human operator.

10. The method as recited in claim 1, wherein the environment attribute data received from the first module comprises features extracted by the first module from data obtained with a microphone and/or a camera, and the human operator data received from the second module comprises features extracted by the second module from data obtained with another camera.

11. A non-transitory storage medium having stored therein instructions that are executable by one or more hardware processors to perform operations comprising:
receiving, by a platform from a first module associated with a device configured to function in an operating environment, environment attribute data concerning attributes of the operating environment;
receiving, by the platform from a second module associated with the device, human operator data concerning attributes of a human operator of the device;
applying an ontology to the environment attribute data and to the human operator data;
based on the applying of the ontology, determining risk state information concerning the human operator; and
updating a digital twin with the risk state information.

12. The non-transitory storage medium as recited in claim 11, wherein the first module comprises a camera and the human operator data was captured by the camera.

13. The non-transitory storage medium as recited in claim 11, wherein the second module comprises a microphone and the environment attribute data was captured with the microphone.

14. The non-transitory storage medium as recited in claim 11, wherein the environment attribute data and/or the human operator data were processed by respective ML (machine learning) models prior to receipt by the platform.

15. The non-transitory storage medium as recited in claim 11, wherein the digital twin represents a condition of the human operator.

16. The non-transitory storage medium as recited in claim 11, wherein the risk state indicates a relative risk that the human operator will be involved in an accident in the operating environment.

17. The non-transitory storage medium as recited in claim 11, wherein when a value of the risk state exceeds a threshold, a remedial action is taken.

18. The non-transitory storage medium as recited in claim 11, wherein the environment attribute data comprises data about physical attributes of the environment.

19. The non-transitory storage medium as recited in claim 11, wherein the human operator data comprises data about physical attributes of the human operator.

20. The non-transitory storage medium as recited in claim 11, wherein the environment attribute data received from the first module comprises features extracted by the first module from data obtained with a microphone and/or a camera, and the human operator data received from the second module comprises features extracted by the second module from data obtained with another camera.
